(19) United States
(12) Patent Application Publication
(10) Pub. No.: US 2004/0064477 A1
(43) Pub. Date: Apr. 1, 2004

(54) System and method of vocalizing real estate web and database property content

(76) Inventor: Kurt A. Swauger, Fair Oaks Ranch, CA (US)

Correspondence Address: BROOKS KUSHMAN P.C., 1000 TOWN CENTER, TWENTY-SECOND FLOOR, SOUTHFIELD, MI, 48075, US

(21) Appl. No.: 10/261,573

(22) Filed: Oct. 1, 2002

(51) Int. Cl. G06F 7/00

(52) U.S. Cl. 707/104.1

(57) ABSTRACT

A system and a method that vocalizes real estate text based content information from real estate web sites, portals, and multi-listing service databases or any other method of collecting and storing real estate listing content, and connecting the user to the party representing the real estate. A call reception application accepting a call from a user, querying the user for specific real estate criteria, accessing real estate databases, and communicating the text-to-speech converted real estate information to the user via a telephone connection or to a user specified facsimile number or wireless device.

### BACKGROUND OF THE INVENTION

1. Field of the Invention

A device for accessing web based and non-web based real estate databases based upon a set of user specified criteria over the public telephone using voice recognition, touch-tone and text-to-speech conversion.

2. Background Art

Locating real estate information through internet web sites, online real estate portals, and Multiple Listing Service (MLS) databases traditionally requires a personal computer and subscription to an internet service provider. Accessing information over the internet also requires an operating knowledge of the computer and internet browsing techniques. In addition, accessing real estate information through a personal computer terminal requires locating the user remotely from the real estate property. Consequently, accessing real estate information over the internet through a personal computer is not a practical source of information for many users.

U.S. Pat. No. 6,385,541 discloses a system and a method for determining a user's geographic location through the position of a wireless device. The system retrieves real estate information relevant to the property located near the wireless device. The real estate information is communicated to the wireless device over a communication network.

The present invention accesses internet and traditional MLS real estate databases over a public telephone network through the user's vocal communications and or touch tone technology. The system recognizes the user's vocal or touch tone commands, and returns vocalized real estate information to the user through the telephone connection. The present invention does not require a wireless device determining the position of the user near the designated real estate property for which information is sought.

### SUMMARY OF THE INVENTION

A system for vocalizing real estate text based content information from a real estate database including a real estate database or multiple real estate databases containing real estate information, a real estate data processing server for accessing the database information and vocalizing the information to a user over a public telephone connection.

A method for vocalizing real estate text based content information from a real estate database over a communications network through a public telephone connection; includes querying the user for specific real estate, accessing real estate information databases, converting the accessed information from text-to-speech, and vocally communicating the real estate information to a user via telephone connection.

### BRIEF DESCRIPTION OF THE DRAWINGS

FIG. 1 is an overview of a system for accessing a local real estate database over a user's public telephone connection. Shown are application units residing on a real estate data processing server used for receiving the user's telephone call and querying a number of databases.

### DETAILED DESCRIPTION OF THE PREFERRED EMBODIMENT(S)

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

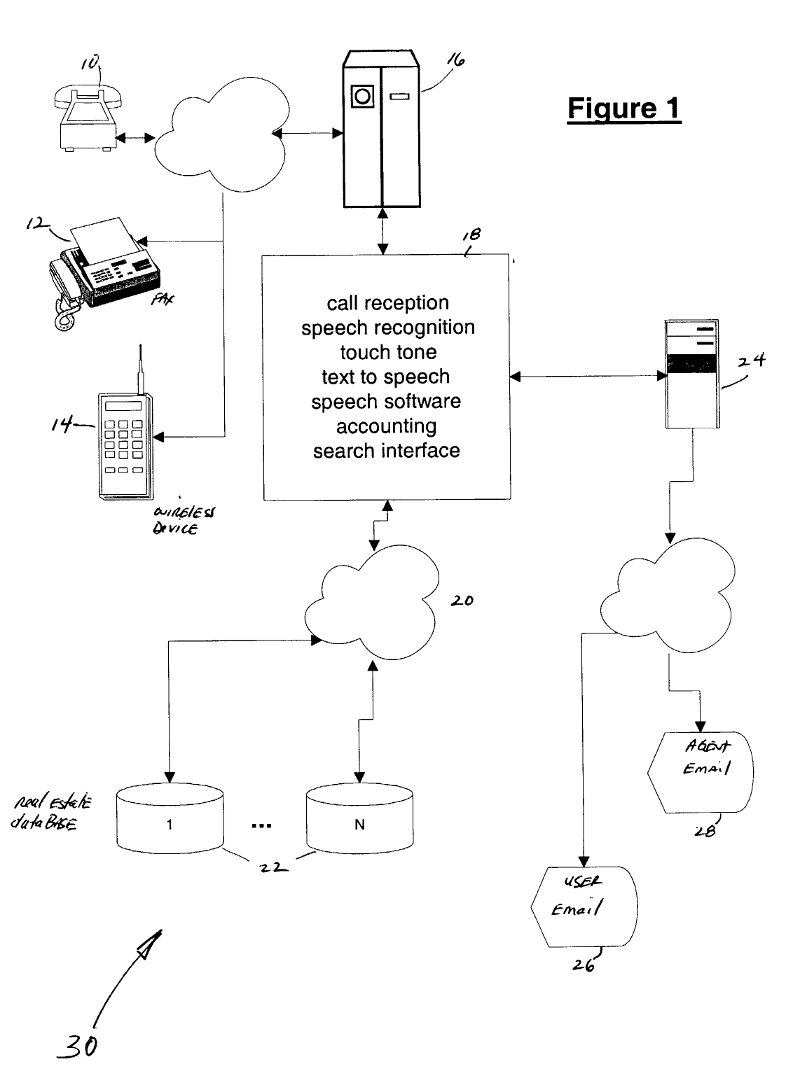

As shown in FIG. 1, a system 30 for accessing a real estate database includes a real estate database 22 that is connected to a communications network 20. A real estate data processing server 18 is also connected to the communications network 20 in order to access the database 22. The user connects to the real estate data processing server 18 through a telephone 10 via a public telephone network 16. A set of information accessed by the real estate data processing server 18 from the real estate database 22 is routed by means of vocal communication to the user's telephone 10. The accessed real estate information can also be routed to a facsimile machine 12, a wireless device 14, or an internet e-mail 26. The user may also request a direct connection to the party representing the desired real estate property through the public telephone connection 10.

The real estate data processing server 18 communicates vocalized real estate information to the user's telephone 10. The real estate data processing server 18 contains a call reception unit that accepts a telephone call from the user via the public telephone network 16. The real estate data processing server 18 contains a speech recognition unit recognizing a user's verbal message signifying the user's search criteria. The user's search criteria can also be entered through the user's telephone 10 touchtones, where a touchtone unit residing on the real estate data processing unit 18 recognizes touchtone inputs communicated from the user's telephone 10. The real estate data processing server 18 accesses the real estate database 22 to search for real estate properties adhering to the user's specified search criteria. The real estate information accessed from the real estate database 22 is converted from text-to-speech and then vocally communicated to the user's telephone 10 through a text-to-speech converter, a vocalizer and a speech software application contained on the real estate data processing server 18. At the user's request, the real estate data processing server 18 connects the user directly to the party representing the real estate property of interest over the telephone 10. The real estate data processing server 18 contains an accounting computer software application that invoices the party representing the real estate property 28 for each connection to an interested user.

The system 30 accesses a number of real estate databases 22 over a communications network 20. The communications network 20 is preferably the internet such that information from real estate web sites, portals, and MLS databases can be accessed by the real estate data processing server 18. The real estate data processing server 18 converts the accessed real estate information from text-to-speech and vocalizes the results to the user's telephone 10 over the public telephone network 16.

The method for accessing real estate database information begins when the user, using a personal telephone 10 over the public telephone network 16, dials the phone number of the real estate data processing system 18. The call reception unit answers the incoming telephone call. The caller is asked to enter a desired property type by either voice command or by touchtone entry from the telephone's key pad 10. The real estate data processing server 18 queries the user for the desired search criteria and the user indicates at least one of zip code, city or state, sales prices range, or property parameter. The real estate data processing server 18 responds to the user's request and searches the real estate database 22 for properties that match the user's criteria. The real estate data processing server 18 returns the number of real estate properties matching the user's specified criteria. The system arranges the real estate listings in priority according to the bid amount placed by the representing party. The representing parties placing higher bids on listings will have those real estate properties placed at the top of the list when the real estate data processing server 18 presents the results to the user. The processing server 18 communicates vocally to the user, through a vocalizer and a speech software application, the number of properties that the system found matching the search criteria. The processing server 18 queries the user for the option to hear information regarding the first real estate property listing. The call reception unit residing on the real estate data processing server 18 receives the user's request and converts the accessed real estate information from text-to-speech through the text-to-speech converter. The real estate information is verbalized to the user over the telephone 10 through the vocalizer. The real estate data processing server 18 queries the user for the option to hear information regarding the next listing, to have the information routed to a facsimile 12, or to be connected directly to the party representing the described real estate property via telephone connection 10. If the user selects the connection to the representing party, the processing server 18 accesses the representing party's telephone number and routes the telephone call to the representing party. If the user chooses the facsimile option, the system queries the user for a facsimile number and the real estate information is routed to the user provided facsimile 12.

When the real estate data processing server 18 connects the user to the party representing the real estate property, the referral is recorded by the real estate data processing system 18 through an accounting software application. The accounting software application generates and submits an invoice to the representing party. The representing party is invoiced for every user referral that is transferred to the representing party.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for accessing real estate information over a communications network, comprising:
a database containing real estate information and property location information related to a set of user specified criteria, the database being accessible over the communications network; and
a real estate data processing server comprising voice recognition, speech applications, text-to-speech conversion, and accounting applications; the processing unit being accessible over the public telephone network; and
a telephone communicating with the real estate data processing server over the telephone network, whereby the data processing server accesses the real estate database for information on a property, or a number of properties, based upon the user's specified criterion, the database returning the real estate information relating to properties adhering to the user's specified criteria.

2. A method for accessing real estate database information over a communications network via a telephone connection, comprising:
accessing a real estate data processing server via the telephone connection;
accepting a call from the user's telephone using a call reception module;
recognizing a verbal message communicated from a user's telephone using a speech recognition module;
accessing a real estate database via the communications network based upon a user's specified criteria;
vocalizing a result based on the user's search criteria to the user via a text-to-speech conversion using a vocalizer; and a speech computer software application;
running an accounting computer software application invoicing the party representing the real estate property adhering to the user's specified criterion.

3. The method of claim 2, wherein a touchtone system recognizes touchtone messages communicated from the user's telephone.

4. The method of claim 2, further comprising:
querying the user for input criteria based on the user's particular real estate preferences;
providing user input to the system based on the system querying the user; and
receiving real estate information regarding a number of the real estate properties based on the user's specified criteria.

5. A method of a user providing real estate information to the system, comprising:
Providing user specified criteria over a telephone network to a real estate data processing server, the data processing server communicating to a real estate database information about real estate properties, the user specified criteria including real estate information and real estate property location information; and the user receiving the location information and the real estate information from the real estate database based on the user's specified criteria.

6. The method of claim 5, wherein providing the user specified criteria further includes the user providing at least one of a property type, zip code, city or state, sales price range, or property parameter.

7. The method of claim 5, wherein providing the user specified criteria includes the user providing a request for connection via telephone communication to the party representing the real estate property.

8. The method of claim 5, wherein providing the user specified criteria includes the user providing a facsimile number for routing of the real estate information adhering to the user specified criteria.

9. A method of a user retrieving real estate information from the system, comprising:
Providing user specified criteria over a telephone network to a real estate data processing server, the data processing server communicating to a real estate database information about real estate properties, the user specified criteria including real estate information and real estate property location information; and the user receiving the location information and the real estate information from the real estate database based on the user's specified criteria.

10. The method of claim 9, wherein receiving the real estate information includes a text-to-speech conversion of the database search results adhering to the user's specified criteria.

11. The method of claim 9, wherein receiving the real estate information includes user receiving a quantity of real estate properties adhering to the user's specified criteria via vocalization over the telephone connection.

12. The method of claim 9, wherein receiving the real estate information includes the user receiving the real estate property content and description adhering to the user's specified criteria via vocalization over the telephone connection.

13. The method of claim 9, wherein receiving the real estate information includes the user receiving the telephone connection directly from the party representing the real estate property adhering to the user's specified criteria.

14. The method of claim 9, wherein receiving the real estate information includes the user receiving the real estate property content and description adhering to the user's specified criteria via a user provided facsimile number.

15. The method of claim 9, wherein the real estate data processing server connecting the user's telephone communication to the party representing the real estate property generates a reference lead to the representing party.

16. The method of claim 9, wherein the real estate data processing server automatically generates an invoice to the party representing the real estate property based on the reference lead generated by the real estate data processing system for connecting the user to the representing party.

17. The method of claim 9, wherein the real estate data processing server sorts multiple real estate property findings from the real estate database adhering to the user's specified criteria according to a highest bid placed by the party representing a real estate property.
